(19) United States
(12) Patent Application Publication
(10) Pub. No.: US 2015/0358756 A1
(43) Pub. Date: Dec. 10, 2015

(54) AN AUDIO APPARATUS AND METHOD THEREFOR

(71) Applicant: KONINKLIJKE PHILIPS N.V., AE Eindhoven (NL)

(72) Inventors: Aki Sakari HARMA, Eindhoven (NL); Sam Martin JELFS, Riethoven (NL); Werner Paulus Josephus DE BRUIJN, Delft (NL)

(21) Appl. No.: 14/760,297

(22) PCT Filed: Jan. 27, 2014
(86) PCT No.: PCT/IB2014/058558

§ 371 Date: Jul. 10, 2015

Related U.S. Application Data
(60) Provisional application No. 61/760,740, filed on Feb. 5, 2013.

(51) Int. Cl. H04S 7/00

(52) U.S. Cl. CPC H04S 7/302; H04S 2400/05; H04S 2400/13

(57) ABSTRACT

An audio apparatus comprises a receiver (201) which receives an audio signal. A generator (203) generates a multi-channel signal including a primary signal and a secondary signal. For example, the multi-channel signal may include a center speech signal and an ambient signal. A driver (205) generates drive signals for a set of loudspeakers (109-15) which for a loudspeaker will include at least a first signal component from the primary 5 signal and a second signal component from the secondary signal. A position circuit (207) determines the position of the loudspeaker (109) and the driver (205) adjusts a level of the primary signal component relative to a level of the secondary signal component in response to the first position relative to a reference position. The approach may allow automated adaptation of the audio rendering to specific loudspeaker configurations and may in particular 10 support optimized rendering for a plurality of listening zones.

### FIELD OF THE INVENTION

The invention relates to an audio apparatus and a method of operation therefor, and in particular, but not exclusively, to rendering of audio to support a plurality of listening zones.

### BACKGROUND OF THE INVENTION

Audio reproduction and rendering is ubiquitous in today's society and has over the years become more advanced and complex. In particular, spatial audio rendering which provides better spatial experiences than conventional mono and stereo reproduction has become more widespread in the last decades.

For example, multi-channel audio rendering, and in particular multi-channel spatial sound rendering, beyond simple stereo has become commonplace through applications such as surround sound home cinema systems. Typically such systems use loudspeakers positioned at specific spatial positions relative to a listening position. For example, a 5.1 home cinema system provides spatial sound via five loudspeakers being positioned with one loudspeaker directly in front of the listening position (the center channel), one loudspeaker to the front left of the listening position, one loudspeaker to the front right of the listening position, one loudspeaker to the rear left of the listening position, and one loudspeaker to the rear right of the listening position. In addition, a non-spatial low frequency loudspeaker is often provided.

Such conventional systems are based on the reproduction of audio signals at specific nominal positions relative to the listening position. One loudspeaker is typically provided for each audio channel, and therefore loudspeakers must be positioned at locations corresponding to the predetermined or nominal positions for the system.

However, such requirements are quite restrictive and there is a desire for increased flexibility in the user experience being provided and in the positioning of the loudspeakers.

For example, there is a desire to allow loudspeakers to be positioned flexibly with the system automatically adapting to the specific loudspeaker configuration. There is also desire for more flexible user scenarios and experiences. In particular, it is often desirable for the sound to be rendered to different areas and with different requirements for each area. For example, in an open plan living area, it may be desirable for the sound rendering to provide a good user experience both for users in e.g. a living room area and in the kitchen area. However, the requirements for the two user experiences may be very different. Also, in order to provide sound in both areas, the user will often be required to position loudspeakers such that they cover both areas, and this is typically in contrast with the requirements for conventional surround sound approaches.

Hence, an improved audio rendering approach would be advantageous and in particular an audio rendering approach that allows increased flexibility, reduced complexity, an improved user experience, a more encapsulating sound experience, reduced spatial distortions, improved support for multiple listening zones, and/or improved performance would be advantageous.

### SUMMARY OF THE INVENTION

Accordingly, the Invention seeks to preferably mitigate, alleviate or eliminate one or more of the above mentioned disadvantages singly or in any combination.

According to an aspect of the invention there is provided an audio apparatus comprising: a receiver for receiving an audio signal; a generator for generating a multichannel signal from the audio signal, the multichannel signal comprising a plurality of signals including at least one primary signal and at least one secondary signal; a driver for generating a set of drive signals comprising at least one drive signal for a loudspeaker of a set of loudspeakers, the set of drive signals comprising at least a first signal component from the primary signal and a second signal component from the secondary signal; a position circuit for determining a first position of the loudspeaker; wherein the driver is arranged to adjust a first level of the primary signal component relative to a second level of the secondary signal component in response to the first position relative to a first reference position.

The invention may allow an improved audio experience in many embodiments. The invention may in many applications allow an improved adaptation of the sound rendered from the loudspeaker to the specific usage of the loudspeaker.

For example, the multi-channel signal may correspond to channels of a surround sound signal and the amount of surround sound and primary (e.g. center channel sound) rendered by the loudspeaker may be adapted based on the position of the loudspeaker. E.g. if the loudspeaker is positioned at a conventional rear loudspeaker position for a surround sound arrangement, the loudspeaker may be driven to only render the surround/ambient sound, whereas if the loudspeaker is positioned far away from the surround sound arrangement the rendered sound may be adapted to include both the surround sound as well as the main signal (such as e.g. the center signal including dialogue). Thus, when used as part of the surround sound arrangement, the loudspeaker renders surround sound whereas if it is used individually, e.g. to provide sound to a secondary area, the loudspeaker can render all sound components of the surround sound signal. Thus, an automatic adaptation of the audio experience provided by the loudspeaker may be achieved.

The reference position may be a predetermined position or may be determined or estimated by the audio system. In some embodiments, the reference position may be a position of another loudspeaker of the set of loudspeakers. In some embodiments, the reference position may correspond to a (nominal) listening position. The position circuit may directly determine the first position as a position relative to the reference position. Thus, the first position may be represented by a value (or values) indicating the first position relative to the reference position.

The primary signal may be e.g. a center signal of a spatial multichannel signal, a front signal of a spatial multichannel signal, a non-diffuse signal, and/or a speech signal. In many embodiments, the primary signal corresponds to sound sources in one direction (or at one position).

The secondary signal may e.g. be a rear signal of a spatial multichannel signal, a side signal of a spatial multichannel signal, a diffuse signal, a background signal and/or an ambient signal. In many embodiments, the secondary signal corresponds to sound sources in multiple directions, and in particular in many cases comprises at least one distributed sound source, such as specifically a sound source that does not have any associated position (e.g. diffuse surrounding background noise).

The adjustment of the first level relative to the second level may specifically be achieved by adjusting the first level, the second level, or both the first and second level. The adjustment of the first level relative to the second level may specifically be achieved by adjusting a gain for the primary signal/primary signal component, adjusting a gain for the secondary signal/secondary signal component, or adjusting both gain for the primary signal/primary signal component and a gain for the secondary signal/secondary signal component.

The set of drive signals may in some embodiments comprise more than one drive signal for at least one loudspeaker. In other embodiments, the set of drive signals may comprise one drive signal for each loudspeaker of the set of loudspeakers. The primary signal component and the secondary signal component may in some embodiments be components of one drive signal, or may in other embodiments be different drive signals provided to the same loudspeaker.

The first reference position may be a single position or be (or be determined from) a set of positions, such as an area or region. Specifically the first reference position may correspond to a listening zone.

In accordance with an optional feature of the invention, the driver comprises a combiner for combining the primary signal and the secondary signal into a single drive signal for the loudspeaker, the weighting of the primary signal relative to the secondary signal being dependent on the first position relative to the first reference position.

This may facilitate operation and/or reduce complexity in many scenarios. In particular, it may allow a single drive signal to be generated for the loudspeaker thereby allowing this to simply render one audio signal comprising both the primary signal component and the secondary signal component.

The combiner may for example comprise a mixer arranged to mix the primary signal and the secondary signal together to form the drive signal. In many embodiments, the driver may further comprise one or more filters or delays applied to the primary signal, the secondary signal or the combined drive signal. In many applications, the combination may include other signals, such as other secondary signals.

In accordance with an optional feature of the invention, the driver is arranged to increase the first level relative to the second level for an increased distance between the first position and the first reference position.

This may provide an improved audio experience in many scenarios. It may typically allow improved adaptation of the rendering to the specific use of the loudspeaker. For example, the increased distance is often indicative of the loudspeaker being used less as an integral part of a surround sound arrangement and more as a stand-alone loudspeaker for providing a complete audio experience.

The ratio of the first level relative to the second level may be a monotonically increasing function of the distance between the first position and the first reference position.

In accordance with an optional feature of the invention, the driver is further arranged to adjust the first level relative to the second level in response to the first position relative to a second reference position.

This may provide increased flexibility and often an improved user experience. In particular, it may provide improved adaption in scenarios where audio is provided to multiple zones.

In many embodiments, the first reference position is associated with a primary listening position, area or zone, and the second reference position is associated with a secondary listening position, area or zone.

In accordance with an optional feature of the invention, the driver is arranged to increase the first level relative to the second level for an increased distance between the first position and the first reference position and to increase the first level relative to the second level for a decreased distance between the first position and the second reference position.

This may provide increased flexibility and often an improved user experience. In particular, it may provide improved adaptation in situations where audio is provided to multiple zones.

In accordance with an optional feature of the invention, the audio signal is a surround audio signal, and the generator is arranged to generate the primary signal from a center channel of the surround audio signal and to generate the secondary signal from at least one non-center channel of the surround audio signal.

This may provide a particularly advantageous audio experience in many embodiments. In particular, it may provide an efficient adaptation of the function of the loudspeaker between a stand-alone loudspeaker and a loudspeaker supporting a surround sound configuration.

In accordance with an optional feature of the invention, the position circuit is arranged to determine a loudspeaker position of at least one loudspeaker of the set of loudspeakers and to determine the reference position from the loudspeaker position.

This may provide improved and/or facilitated operation. The reference positions may be determined as relative positions, such as e.g. with respect to one or more of the existing loudspeakers.

In accordance with an optional feature of the invention, the driver is arranged to determine a speech clarity indication for sound rendered from the loudspeaker, and to adjust the first level relative to the second level in response to the speech clarity indication.

This may provide an improved audio experience in many scenarios. In particular, the approach may allow the system to automatically adapt to provide clearly perceptible speech in a secondary listening zone.

In accordance with an optional feature of the invention, the audio apparatus further comprises a user detector for generating a user presence indication indicative of a user presence in a listening zone; and the driver is arranged to adjust the first level relative to the second level in response to the user presence indication.

This may allow improved audio adaptation, and may in particular allow adaptation to the current use scenario, and/or allow trade-off between the audio experiences provided to users in different listening zones without compromising performance if only one listening zone is occupied.

In accordance with an optional feature of the invention, the user presence indication is indicative of a user position; and wherein the driver is arranged to reduce the first level relative to the second level in response to the user presence indication indicating a user position in a primary listening zone.

This may allow improved audio experience with a priority for users in the primary listening zone.

In accordance with an optional feature of the invention, the user presence indication is indicative of a user position; and wherein the driver is arranged to increase the first level relative to the second level in response to the user presence indication indicating a user position in a secondary listening area.

This may allow improved audio experience for users in the secondary listening zone while allowing optimization of the audio experience in the main listening zone when the secondary listening zone is not occupied.

In accordance with an optional feature of the invention, the audio apparatus further comprises the loudspeaker, and the loudspeaker is arranged to render the primary signal with a different radiation pattern than a radiation pattern for the secondary signal.

This may allow improved audio rendering in many scenarios and may specifically allow an improved user experience. The radiation pattern for the primary signal may specifically be a narrower pattern than the radiation pattern for the secondary signal. The approach may e.g. allow a more diffuse rendering of ambient or background signals without impact on the rendering of the main (e.g. speech) signal.

In accordance with an optional feature of the invention, the position circuit is arranged to categorize at least some of the loudspeakers of the set of loudspeakers into categories comprising at least a first category associated with loudspeakers supporting a primary listening zone and a second category associated with loudspeakers supporting a secondary listening zone; and where the driver is arranged to determine the first level relative to the second level in response to the categorization of the loudspeaker.

This may allow improved audio rendering and specifically may allow the system to support multiple listening zones by adapting the sound rendering for the loudspeakers depending on their relation to the multiple listening zones.

In accordance with an optional feature of the invention, the first category is associated with loudspeakers not supporting the secondary listening zone and the second category is associated with loudspeakers not supporting the primary listening zone (103), and the categories further comprises a third category associated with loudspeakers supporting both the primary listening zone and the secondary listening zone.

In accordance with an optional feature of the invention, the driver is arranged to set the first level relative to the second level higher when the loudspeaker is in the second category than when it is in the first category.

This may allow efficient adaptation of the use of the loudspeaker to the specific preferences in the primary and secondary listening zones. For example, it may allow a loudspeaker to automatically be provided with a surround signal for a surround sound configuration when positioned to support the primary listening zone and to be provided with both surround and e.g. speech components when positioned to support the secondary listening zone.

In accordance with an optional feature of the invention, the driver is arranged to generate a single drive signal for the loudspeaker from a set of signals of the plurality of channel signals, the set of signals being dependent on which category the loudspeaker belongs to.

This may allow improved adaptation. For example, when the loudspeaker belongs to the first category, the drive signal may be generated to correspond directly to one channel of the multi-channel signal whereas if the loudspeaker belongs to the second category the drive signal may be generated by combining a plurality, and possibly all, channels of the multi-channel signal. Thus, the approach may allow an automatic adaptation of the loudspeaker from being a single channel loudspeaker supporting a spatial multi-channel rendering together with other loudspeakers to being a single stand-alone loudspeaker rendering the complete multi-channel signal.

Specifically, the driver may be arranged to combine all signals of the plurality of channel signals into a single drive signal for the loudspeaker when the loudspeaker belongs to the second category.

In accordance with an optional feature of the invention, the driver is arranged to distribute the plurality of channels signals over a set of loudspeakers which includes only loudspeakers in a subset of categories associated with loudspeakers supporting the primary listening zone.

This may allow the system to automatically reconfigure the reproduction of a spatial multi-channel signal to the available loudspeakers in each listening zone. Thus, the approach may e.g. allow a user to simply move a loudspeaker from a rear surround position in a main listening zone to a secondary listening zone. The system may not only automatically change the rendering of the system to provide sound that is suitable for the second listening zone from the loudspeaker but may also allow the driving of the remaining loudspeakers in the main listening zone to be optimized for the changed loudspeaker configuration.

The subset of categories may specifically be the first category or the second category. In embodiments where a third category, e.g. associated with loudspeakers positioned in a listening zone acoustically coupled with both the primary listening zone and the secondary listening zone, is included, such a category may in some embodiments be included in the subset and may in other embodiments not be included.

In accordance with an optional feature of the invention, the audio apparatus further comprises: a test generator for generating a test audio signal and feeding it to at least one loudspeaker of the set of loudspeakers; a microphone receiver for receiving a microphone signal from at least one of a microphone associated with a loudspeaker of the set of loudspeakers and a microphone associated with a listening zone; and wherein the position circuit is arranged to categorize the loudspeakers in response to the microphone signal.

This may facilitate operation and provide a low complexity approach for setting up the system.

In accordance with an optional feature of the invention, the audio apparatus further comprises the loudspeaker which is an adjustable multichannel loudspeaker; and the apparatus is arranged to switch the loudspeaker between a single channel mode and a multi-channel mode in response to the categorization of the loudspeaker.

This may provide improved flexibility and support for multiple listening zones. For example, the loudspeaker may be switched between a single channel unit rendering a single sound signal or may radiate multiple sound signals, e.g. corresponding to a virtual surround sound rendering.

In accordance with an optional feature of the invention, the audio apparatus further comprises a user detector for generating user position indications indicative of user positions; and wherein the position circuit is arranged to determine the first reference position in response to the user position indications.

This may provide an improved adaptation and may for example allow automatic adaptation of the system to the specific user behavior. The approach may reduce the amount of user input required and may facilitate operation. For example, the system may automatically adapt to provide optimized sound rendering for the specific speaker arrangement and user behavior.

In some embodiments, the apparatus may comprise a user detector for generating user position indications indicative of user positions; and the position circuit may be arranged to determine the second reference position in response to the user position indications.

According to an aspect of the invention there is provided a method of operation for an audio system, the method comprising: receiving an audio signal; generating a multichannel signal from the audio signal, the multichannel comprising a plurality of signals including at least one primary signal and at least one secondary signal; generating a set of drive signals comprising at least one drive signal for a loudspeaker of a set of loudspeakers, the set of drive signals comprising at least a first signal component from the primary signal and a second signal component from the secondary signal; determining a first position of the loudspeaker; and adjusting a first level of the primary signal component relative to a second level of the secondary signal component in response to the first position relative to a first reference position.

These and other aspects, features and advantages of the invention will be apparent from and elucidated with reference to the embodiment(s) described hereinafter.

### BRIEF DESCRIPTION OF THE DRAWINGS

Embodiments of the invention will be described, by way of example only, with reference to the drawings, in which

FIG. 1 illustrates an example of a possible audio speaker arrangement in an open plan room;

FIG. 2 illustrates an example of an audio apparatus in accordance with some embodiments of the invention;

FIG. 3 illustrates an example of a combiner for the audio apparatus of FIG. 2;

FIG. 4 illustrates an example of a measured acoustic impulse response; and

FIG. 5 illustrates an example of a measured acoustic impulse response.

### DETAILED DESCRIPTION OF SOME EMBODIMENTS OF THE INVENTION

The following description focuses on embodiments of the invention applicable to rendering of surround sound audio. However, it will be appreciated that the invention is not limited to this application but may be applied to many other audio signals and systems.

The description furthermore focusses on an application wherein the audio system may be used to cover multiple listening zones, and specifically a primary listening zone and a secondary listening zone. The primary and secondary listening zones may in some embodiments simply be designated as such by the audio system. In other embodiments, the primary and secondary zones may be differentiated e.g. by the sound rendering in the primary zone being prioritized higher than the secondary zone, by some loudspeakers always being designated as the primary zone, or by the surround sound experience only being provided in the primary zone.

The system may specifically be useful for the home audio rendering segment and may provide an improved and more flexible audio rendering in the home environment.

The system may specifically address the problem that conventional multichannel audio setups do not fit conveniently in most living rooms and furthermore cannot provide a good sound reproduction outside of the best listening spot. Modern rooms are often multifunctional spaces consisting of e.g. a kitchen area, a dining area, and a living room area which again may support multiple functions including e.g. television watching, music listening, entertaining, etc. The problem is further exacerbated in open plan arrangements, such as e.g. where kitchens, dining rooms and living rooms are combined in a single shared space.

It is desired that audio systems can provide audio for a plurality of areas, and especially in multifunction rooms. Indeed, it is also desired that the rendered audio can be adapted to the specific listening behavior that is typical for the different areas.

For example, if a user wants to listen to a television program while sitting at the dining table whereas another user is watching the news while sitting in front of the television, the appropriate audio rendering should simultaneously be provided at both the dining table and at the best listening position in front of the television, as well as possibly in other areas of the room. The desired sound reproduction would in this scenario advantageously provide a spatial surround sound image in the best listening area in front of the television while at the same time providing a good listening experience for a user in other areas of the room.

The most feasible way to reproduce audio in a large listening area is to distribute loudspeakers around the room. However, in practice, real homes and users impose strict restrictions for the placement of the devices and it is also desirable to minimize the number of loudspeaker cables running through the room. Therefore, whereas the best audio performance can be achieved by providing a full surround sound loudspeaker set-up for each desired listening position, this would require an impractical number of loudspeakers. Furthermore, the audio from the different loudspeakers set-ups would interfere with each other and thereby degrade the audio experience.

A practical solution in many scenarios is to focus on providing a full surround sound experience for a primary listening zone with a reduced audio experience at secondary listening zones. This may for example be achieved by positioning loudspeakers to surround the primary listening zone. Fewer loudspeakers, and often only a single loudspeaker, may be positioned close to the secondary listening zone to provide an improved audio experience in this zone but without providing a full surround experience.

Furthermore, it is desirable that the same audio system and set of loudspeakers can be used in very different environments. For example, an audio system may be marketed as a system which provides a full, say 5.1 or 7.1, surround sound system. Thus, in normal operation the system supports five or seven loudspeakers (plus an LFE loudspeaker) which are positioned around a primary listening zone. However, in order to support a secondary listening zone, the system may allow one or two loudspeakers to be moved from the nominal position, and may e.g. be positioned close to the secondary listening zone. However, in such a scenario, the audio experience will not be substantially improved if special considerations are not taken. For example, moving one of the front loudspeakers will very substantially reduce the surround sound experience. Moving a surround loudspeaker will have much less impact on the surround sound experience of the primary listening zone but will not provide substantial improvement at the secondary listening zone as it will only provide ambient or background sound. As such it may even degrade the audio experience.

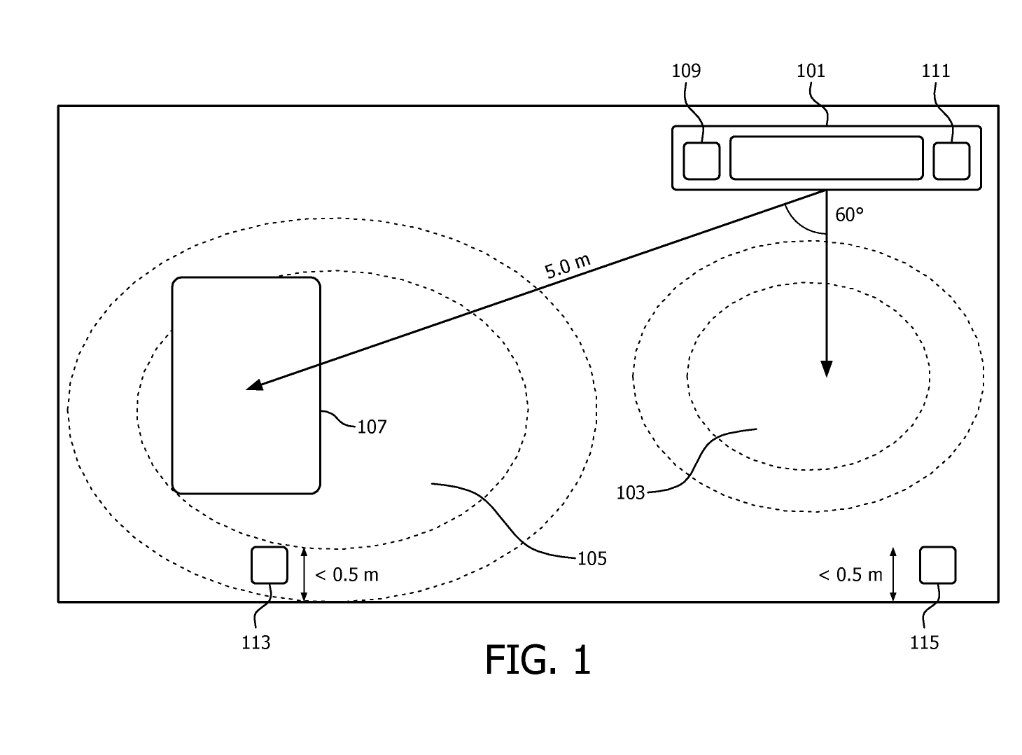

FIG. 1 illustrates an example of a possible arrangement in a room. The scenario will be used as an example for demonstrating the operation of an exemplary audio system in accordance with some embodiments of the invention.

In the example, the room includes a television 101. In front of the television 101 there is a primary listening zone 103 for which the audio system preferably provides a strong surround sound experience.

In addition, a secondary listening zone 105 is supported. In the example, the secondary listening zone corresponds to a kitchen/dining area of the room as exemplified by a dining table 107.

In the example, the audio system includes four loudspeakers 109-115. In the example, the system includes front stereo loudspeakers in the form of a front left loudspeaker 109 and a front right loudspeaker 111. These loudspeakers provide strong primary audio sources, such as speech. In the example, the audio system further comprises two satellite loudspeakers that may be used as surround loudspeakers. Namely, a first loudspeaker 113 may be configured as a left surround/rear loudspeaker and a second loudspeaker 115 which can be configured as a right surround/rear loudspeaker. Thus, in a conventional surround sound configuration the two satellite loudspeakers 113, 115 are configured as two surround loudspeakers. Thus, the two satellite loudspeakers 113, 115 in such an arrangement provide audio which is typically of an ambient or background character.

It will be appreciated that other numbers of loudspeakers (and other configurations) can be used in other embodiments. For example, most surround sound systems furthermore include a center loudspeaker positioned between the front stereo loudspeakers 109, 111.

However, in the example of FIG. 1, the first loudspeaker 113 has been moved from the nominal position behind the primary listening zone 103 to a position proximal to the secondary listening zone 105. This may provide an improved audio rendering for the secondary listening zone 105. Indeed, instead of merely providing the ambient audio of the left surround channel, the audio system is arranged to automatically reconfigure itself such that the rendered signal may include higher levels of main audio components, such as e.g. speech rendered by the front stereo loudspeakers.

As a specific example, the audio system may receive a stereo signal which it is desired should be rendered as a spatial signal for at least the primary listening zone 103. The stereo signal may be presented directly at the front stereo loudspeakers 109, 111. In addition, the drive signals for the satellite loudspeakers 113, 115 should be selected such that both the sound image in the best listening position (the primary listening zone 103) and the listening experience in other parts of the room is optimized. If the stereo content is simply copied to the two satellite loudspeakers 113, 115, the spatial image and localization of central sound sources will be seriously impaired: central voices will be perceived to be distributed rather than being a specific point source even for a listener in the best listening position. Furthermore, the stereo image will be blurred and may lack clear left/right separation. For example, in the setup of FIG. 1, the presence of a center voice in one of the satellite loudspeakers 113, 115 will make the center speech sound strange because the voice is partly played from a loudspeaker behind the user. The same problem is also produced by using a monophonic downmix signal in the satellite loudspeakers.

Using traditional solutions for upmixing from stereo content to multichannel will generate rear surround channels in which the center speech has been removed, and thus the signals will substantially correspond to ambient or background sound signals. This will result in a desirable spatial audio experience for a listener in the primary listening zone 103 when using a conventional loudspeaker setup where the rear surround loudspeakers (i.e. in this case the satellite loudspeakers 113, 115) are positioned close to the primary listening zone 103. However, when the loudspeaker configuration is as shown in FIG. 1, it will lead to undesirable effects. Indeed, whereas the approach may allow the central dialogue to be removed from the second loudspeaker 115 as desired, it will also remove the central dialogue from the first loudspeaker 113. As a result, a user by the dining table will mainly hear speech content from the distant front stereo loudspeakers 109, 111 and the proximal first loudspeaker 113 will only provide interfering background audio. Thus, in such an example, the surround content played back from the first loudspeaker 113 creates a room-wide enveloping spatial effect which may be desired for a user in the primary listening zone 103 but at the same time makes speech listening difficult for a user in the secondary listening zone 105.

However, in some embodiments of the invention the sound rendered by the first loudspeaker 113 will be modified depending on the position. Specifically, the audio system may decompose the stereo input signal into component signals, including at least one primary signal and one secondary signal where the primary signal may correspond to a center channel and the secondary signal may correspond to an ambient signal. The secondary signal may be a diffuse sound signal whereas the primary signal is a less or non-diffuse signal.

For example, the stereo signal may be decomposed into three component signals consisting of a center signal and two ambience signals. The drive signal for the first loudspeaker 113 is then generated by mixing these signals depending on the position of the first loudspeaker 113. Thus, the signals are mixed in different ways for the loudspeakers depending on their position in the room and their relative distances. Specifically, when the first loudspeaker 113 is estimated to be close to the primary listening zone 103, the level of the center signal is low (or zero) and the level of the ambient signal is high. If the first loudspeaker 113 is close to the secondary listening zone 105, the level of the center signal will however be increased and may substantially correspond to that of the ambient signals. Thus, if the system detects that the first loudspeaker 113 is proximal to the primary listening zone 103, the first loudspeaker 113 will be driven as it was a surround sound loudspeaker. However, if the system detects that the first loudspeaker 113 is proximal to the secondary listening zone 105, the first loudspeaker 113 will be driven as it was a single mono loudspeaker reproducing the combined audio content of the original stereo signal. Thus, the driving of the first loudspeaker 113 is automatically adapted to provide the desired function.

As will be described in more detail later, the positions of the loudspeakers can e.g. be measured in a separate calibration phase of the system, online calibration using adaptive filters, or by manual setup based on user input. The measurement may be performed using microphones integrated into the individual loudspeaker devices or by using a separate device such as a smartphone or a remote controller.

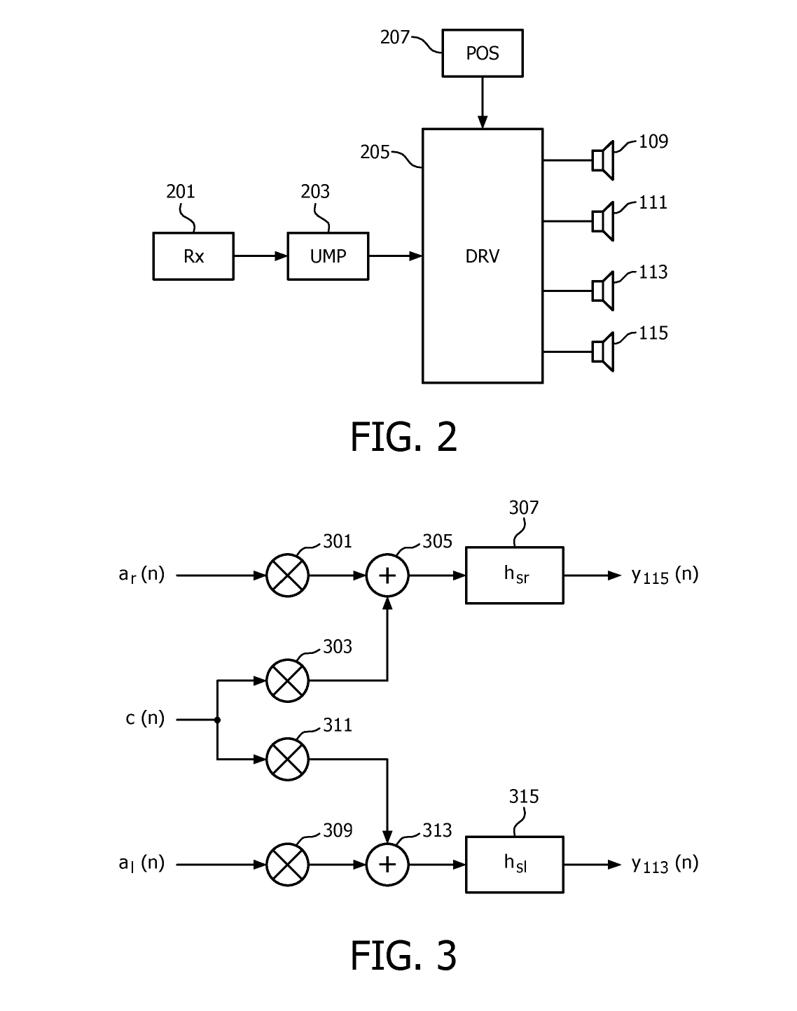

FIG. 2 illustrates an example of an audio system comprising an audio apparatus in accordance with an embodiment of the invention. The apparatus may for example be implemented as an audio amplifier, an AV receiver, a home cinema system etc.

The audio apparatus comprises a receiver 201 which receives an audio signal to be rendered by the audio system. The audio signal may for example be a traditional stereo signal, a mono or stereo downmix of a multi-channel signal, or may itself be a multi-channel signal, such as for example a full surround signal comprising spatial audio signals. The audio signal may be received from any internal or external source.

The receiver 201 is coupled to a multi-channel signal generator 203 which is arranged to generate a multi-channel signal that comprises a plurality of signals. The plurality of signals includes at least one primary signal and one secondary signal.

The primary signal may be e.g. a center signal of a spatial multichannel signal, a front signal of a spatial multichannel signal, a non-diffuse signal, and/or a speech signal. In many embodiments, the primary signal corresponds to sound sources in one direction (or at one position). The primary signal may predominantly comprise spatially well-defined sources (e.g. at least half of the power will be comprised in single point sources)

The secondary signal may e.g. be a rear signal of a spatial multichannel signal, a side signal of a spatial multichannel signal, a diffuse signal, a background signal and/or an ambient signal. In many embodiments, the secondary signal corresponds to sound sources in multiple directions, and in particular in many cases comprises at least one distributed sound source, such as specifically a sound source that does not have any associated position (e.g. diffuse surrounding background noise). The secondary signal may predominantly comprise sound sources that are not well-defined sources (e.g. less than half of the power will be comprised in single point sources, and typically less than a quarter of the power will be comprised in single point sources).

In the specific example, the input audio signal may be a conventional stereo signal which is decomposed by the multi-channel signal generator 203 into a center signal, and a right and left ambient signal. Thus, an upmixing is performed wherein a primary signal is generated as a center signal and two secondary signals are generated as respectively a left and right ambient signal.

The decomposition may for example be based on dividing the stereo signal into time frequency tiles and then for each time-frequency tile pair generating a sum time-frequency tile. The center signal can then be generated from these sum-frequency tiles. Furthermore, for each of the original time-frequency tiles, the residual value is determined, and thus two residual time-frequency tiles are generated. These are then used to generate two ambient signals. More details of such an approach may e.g. be found in WO2011151771A1.

Thus, in this way the input stereo signal consisting of two discrete time signals xₗ(n) and xᵣ(n) are decomposed to generate three signals which are the center signal c(n) and two ambience signals aₗ(n) and aᵣ(n), respectively. The center signal is then considered to be the primary signal and the two ambient signals are considered to be secondary signals.

As a result of this decomposition, a primary signal is generated which is likely to contain the most important sound of the original audio signal and specifically spatially well-defined audio sources. For example, the primary signal is likely to contain the speech and dialogue of the original signal. Similarly, two secondary signals are generated which are likely to predominantly contain diffuse background and ambient sounds. Thus, the primary center signal is likely to contain specific direct sound sources, whereas the secondary signal contains a higher degree of diffuse and less specific sound sources.

It will be appreciated that in other embodiments, the primary and secondary signals may be generated in other ways and from other signals. For example, if the input signal directly is a spatial multi-channel signal, the multi-channel signal generator 203 may simply generate the plurality of signals as the individual channel signals of the input signal. For example, if a 5.1 surround sound signal is received, the multi-channel signal generator 203 may simply generate the primary signal as the center channel signal and the secondary signal as one of the surround signals. Indeed, in such a scenario, the multi-channel signal generator 203 may simply forward all the received multichannel signals. Thus, the audio signal may in some embodiments be a surround audio signal, and the multi-channel signal generator 203 may directly generate the primary signal from a center channel of the surround audio signal, and generate the secondary signal from at least one non-center channel of the surround audio signal.

As another example, the input signal may be a mono or stereo downmix of a surround sound signal, e.g. together with parametric upmix data. In such an example, the multi-channel signal generator 203 may upmix the received downmix to generate the corresponding spatial multi-channel signal. It may then proceed as for the example when the input signal is a surround signal, i.e. it may proceed to generate one or more of the upmix audio signals as a primary signal and one or more of the upmix audio signals as a secondary signal. For example, it may designate the front channel signals (e.g. the right front, left front and center signals) as primary signals and the surround/rear signals as secondary signals.

The multi-channel signal generator 203 is coupled to a driver 205 which is fed the signals generated by the multi-channel signal generator 203 and which is capable of generating drive signals for a set of loudspeakers 109-115 from these signals.

The driver 205 is furthermore coupled to a position circuit referred to as a position processor 207. The position processor 207 is arranged to determine a first position of the first loudspeaker 113, and typically to determine the position of all the loudspeakers 109-115.

Specific examples of how the position processor 207 may determine the positions will be provided later. For example, in some situations, specific processes may be performed to automatically estimate the positions. In other embodiments, the positions of the loudspeakers may simply be entered by a user via a suitable user interface, such as e.g. a remote control or an attached computing device (e.g. a smartphone or tablet).

The position processor 207 may provide the positions of the loudspeakers to the driver 205. In addition, the position processor 207 provides at least one reference position. The reference position is associated with the primary listening zone 103 and thus is considered to be at least a rough indication of the primary listening zone 103.

In some embodiments, the reference position may simply be a predetermined position e.g. provided as relative position with respect to one or more of the loudspeakers 109-115. For example, the reference position may be the position of one of the front loudspeakers 109, 111. As the primary listening zone 103 is typically relatively close to the front loudspeakers 109, 111, this reference position may be used to provide an indication of how far other loudspeakers are from the front loudspeakers 109, 111 and thus from the primary listening zone 103. Such an approach may be sufficient in many embodiments.

However, in other embodiments improved performance may e.g. be achieved by determining the reference position associated with the primary listening zone 103 as having a predetermined offset relative to the front loudspeakers 109, 111. For example, a reference position may be determined as midway between and, say, 2 meters in front of the two front loudspeakers 109, 111.

Instead of providing the position of the first loudspeaker and the reference position as separate position indications, the position processor 207 may simply provide a single position indication which is indicative of a position offset between a reference position and the first position. For example, a position indication in the form of a distance between the positions of the first loudspeaker 113 and the reference position may be provided. Indeed, the position processor 207 may directly determine the first position (and indeed all positions) with reference to a position that may be considered as the reference position. For example, all positions may be determined relative to one of the front loudspeaker positions and this position may accordingly be considered the reference position for the primary listening zone 103. In such a case, all positions are accordingly inherently determined relative to the reference position for the primary listening zone 103, and specifically relative to the position of one of the loudspeakers.

The driver 205 is arranged to generate a set of drive signals for the set of loudspeakers 109-115.

In the specific example, the drive signals for the two front stereo loudspeakers 109, 111 are simply generated to correspond to the corresponding signals of the multi-channel signal, and indeed may simply be generated to correspond to the input stereo signal. As such, the drive signals for the front stereo loudspeakers 109, 111 may be generated by amplification and filtering of the input stereo signals. Furthermore, this operation may be static in the sense that it is not dependent on e.g. the positions of the loudspeakers, rather the signals for the front stereo loudspeakers 109, 111 may always be generated to correspond to the input stereo signal.

In contrast, the generation of the drive signals for the satellite loudspeakers 113, 115 is adaptive and is specifically adapted by the system dependent on the position of the loudspeakers. Specifically, the drive signals for the satellite loudspeakers 113, 115 are generated to include contributions from the primary signal and at least one of the secondary signals. Thus, the drive signals for the satellite loudspeakers 113, 115 will include at least a primary or first signal component which is generated from the primary signal and a secondary or second signal component which is generated from the secondary signal. The relative levels of the primary signal component and the secondary signal component is dependent on the position of the individual loudspeaker relative to the reference position.

FIG. 3 illustrates an example of an implementation of the driver 205 for the example where the multichannel signal is generated by decomposing the input stereo signal as a center signal c(n), a left ambient signals aₗ(n) and a right ambient signals aᵣ(n).

In such an example, the front stereo loudspeakers 109, 111 may be driven by the input stereo signal. However, as another example, the drive signals for the front stereo loudspeakers 109, 111 may be generated from the decomposed signal, and may specifically be generated as:

y₁₀₉(n)=c(n)+aₗ(n)

y₁₁₁(n)=c(n)+aᵣ(n)

Thus, the sound rendered from the front stereo loudspeakers 109, 111 corresponds to the primary signal combined with the corresponding ambient/background signal.

In the example, the drive signals for the satellite loudspeakers 113, 115 are also generated by combining the primary signal (i.e. the center signal) and the appropriate ambient signal (i.e. the one corresponding to the side of the individual satellite loudspeakers 113, 115). However, in contrast to the front stereo loudspeakers 109, 111 the combination for the satellite loudspeakers 113, 115 is not constant but varies depending on the position of the individual satellite loudspeakers 113, 115.

Specifically, as shown in FIG. 3, the right ambient signal is multiplied by a gain 301 and the center signal is multiplied by a gain 303. The results are summed in a summation unit 305. The sum signal is then fed to a filter hₛᵣ 307 to generate the drive signal for the right surround loudspeaker 115.

Similarly, the left ambient signal is multiplied by a gain 309 and the center signal is multiplied by a gain 311. The results are summed in a summation unit 313. The sum signal is then fed to a filter hₛᵣ 315 to generate the drive signal for the right surround loudspeaker, i.e. for the first loudspeaker 113.

The filter may specifically be a delay which delays sound components from the satellite loudspeakers 113, 115 relatively to the front stereo loudspeakers 109, 111. This may ensure that in particular sound from the center signal rendered from the front stereo loudspeakers 109, 111 can be ensured to arrive at a listener before the corresponding sound from the satellite loudspeakers 113, 115. Due to the human perceptions ability to determine direction based on the first arrived sound wave front, this may provide a stronger spatial perception that the source of the center signal is from the front stereo loudspeakers 109, 111. The effect is known as the Haas effect.

The gains are dependent on the positions of the satellite loudspeakers 113, 115 relative to the reference position. Specifically, the gain for the center signal is increased relative to the gain for the ambient signal for an increasing distance from the first reference position. Thus, in the example of FIG. 1, the second loudspeaker 115 is relatively close to a reference position corresponding to the primary listening zone 103. Therefore, the gain for the center signal is relatively low whereas the gain for the right ambient signal is relatively high. Specifically, the gain for the center signal may be zero and the drive signal may be generated to correspond directly to the right ambient signal. Thus, the second loudspeaker 115 will render only the ambient signal, and will thus support the spatial audio experience for a listener in the primary listening zone 103 by providing surround sound from the rear of the listener.

In contrast, the first loudspeaker 113 is relatively far away from the reference position for the primary listening zone 103. Therefore, the gain for the center signal is increased substantially whereas the gain for the left ambient signal may be reduced, or may be maintained constant (or even increased but less than the gain increase for the center signal). As a result, the first loudspeaker 113 will render audio which is the combination of the left ambient signal and the center signal, i.e. it will render both the primary signal and a secondary signal. This will allow the first loudspeaker 113 to support listeners in the secondary listening zone 105 who would otherwise find it difficult to hear the center channel from the front stereo loudspeakers 109, 111. Indeed, the first loudspeaker 113 may provide a full rendering of the audio content of the input stereo signal to listeners in the secondary listening zone 105.

Thus, in the example, the driver 205 is arranged to modify a first level of the primary signal component relative to a second level of the secondary signal component in response to the first position relative to the first reference position. Thus, the relative contribution from the center signal and the ambient signal for each loudspeaker depends on the position of that loudspeaker relative to the reference position. When the distance increases, the gain/level of the primary signal component is increased relative to the gain/level of the secondary signal. The ratio between the gains/levels may specifically be a monotonic function of the distance between the loudspeaker position and the reference position.

In the example, the driver 205 comprises a combiner which combines the primary signal and the secondary signal into a single drive signal for the first loudspeaker 113. The combiner is in the form of a mixer which in the specific example generates the drive signal as a weighted summation of the primary signal and one secondary signal. It will be appreciated that other combinations may be used in other embodiments, such as combinations including individual filters for the individual signals etc. In the combination, the relative weights for the primary signal and the secondary signal are dependent on the position of the corresponding loudspeaker and specifically on the distance from the loudspeaker position to the reference position.

In some embodiments, multiple drive signals may be provided to a single loudspeaker. Thus, the set of drive signals generated by the driver 205 may comprise a plurality of drive signals for one or more of the set of loudspeakers 109-115 driven by the driver. For example, rather than combining the gain compensated center and ambient signals, these may be fed directly to the loudspeaker which may comprise multiple audio transducers for individually rendering the two signals, or which may itself comprise a signal combiner.

It will be appreciated that the driver 205 adjusts the relative gains/levels depending on the position of the loudspeaker and that this may be achieved by any suitable means. For example, the gain/level of one signal component may be constant with the gain/level of the other signal component being modified, or both gain/levels may be modified. Furthermore, it will be appreciated that the modifications may be subject to other considerations and requirements. For example, the relative level of the signal components may be subject to a requirement that the overall level of the generated drive signal should have a given value. E.g. it may be required that the total volume of sound being rendered by the loudspeaker is constant with the relative contribution of the signal components being adjusted within this restriction.

In the described example, the loudspeaker signals are thus generated by mixing of the three decomposed signals, i.e. of the center signal and the two ambient signals. The approach may be based on first calibrating the system to determine which loudspeakers of the system represent the front stereo loudspeakers 109, 111. Subsequently, the distances and angles of the satellite loudspeakers 113, 115 relative to the front stereo loudspeakers 109, 111 can be determined as a part of the same calibration measurement. It will be appreciated that the skilled person will be aware of various algorithms for determining loudspeaker positions.

The drive signals for the front stereo loudspeakers 109, 111 are then generated from the decomposed signals:

y₁₀₉(n)=c(n)+aₗ(n)

y₁₁₁(n)=c(n)+aᵣ(n)

The drive signals for the satellite loudspeakers 113, 115 are formed with the help of filtering operators F₁₁₃ and F₁₁₅, respectively, such that

y₁₁₃(n)=F₁₁₃[c(n),aₗ(n),aᵣ(n)]

y₁₁₅(n)=F₁₁₅[c(n),aₗ(n),aᵣ(n)]

In some embodiments, the operation may (as mentioned) include the application of a delay to the signals. The purpose of the delay is to make sure that the sound is perceived to originate from the front loudspeakers 109, 111 for all listeners, i.e. for a listener closer to one of the satellite loudspeakers 113, 115 than to the front stereo loudspeakers 109, 111. In some embodiments it is possible to determine the first reference position associated with the primary listening zone 103 using a hand-held device (microphone or sound actuator) which can be positioned freely. Measurements may e.g. be performed between the loudspeakers 109-115 to determine relative positions of these. The location of the reference position associated with the primary listening zone 103 may then e.g. be determined a position, say, 3 meters in front of the front stereo loudspeakers 109, 111.

In addition, the calibration measurement may also be used to determine the left/right assignment parameter gₗᵣ of the signals such that if a loudspeaker is on the left hand side of the listening area (such as the first loudspeaker 113 in FIG. 1) the apparatus applies a gain gₗᵣ=0 to the component signal aᵣ(n) and a non-zero gain to the component signal aₗ(n). In some embodiments, the value of the left-right coefficient may be linked to the angular direction of the satellite loudspeaker such that

gₗᵣ=(sin(α)+1)/2

The center signal is preferably handled so that the system provides improved clarity and intelligibility of speech in other listening areas (such as at the dining table 107 in FIG. 1) and still provides the best clarity and natural localization of the center content in the primary listening zone 103. In the system of FIG. 1, this may be obtained by a relative increase of the center content in the first loudspeaker 113 which is close to the dining table, and an attenuation of the level of the center signal c(n) in the other satellite loudspeaker 115 which is close to the primary listening zone 103. In some embodiments, the amplitude of the center signal in the satellite loudspeakers 113, 115 only depend on the distance d_{S} of the satellite loudspeaker from the best listening position. A convenient gain for the signal c(n) is given by:

g_{c}=1−e^{d}^{_{S}}^{²}_{/v}

where typically v=2.

In the example, the complete mixing rule for a satellite loudspeaker 113, 115 may accordingly be:

y_{S}(n)=h_{S}*(g_{C}c(n)+gₗᵣaₗ(n)+(1−gₗᵣ)aᵣ(n))

where h_{S} is an impulse response of a rendering filter and the asterisk denotes convolution of the time-domain signals. Typically h_{S} is a simple delay filter that compensates for the time of sound propagation from the front stereo loudspeakers 109, 111 to the area around the satellite in order to improve the localization of the sound to the direction of e.g. a television 101 situated between the front stereo loudspeakers 109, 111.

In the previous example, the relative gains/levels for the primary signal and the secondary signal were dependent on the distance between the loudspeaker and a reference position which corresponded to the primary listening zone 103. In some embodiments, the levels may be dependent on relationships to more than one reference position, and may specifically also be dependent on the distance to a second reference position associated with the secondary listening zone 105.

In such embodiments, the position processor 207 may determine a second reference position considered to be indicative of the secondary listening zone 105 in addition to the first reference position associated with the primary listening zone 103. In some embodiments, complex approaches may be used to determine the second reference position, e.g. including microphones being positioned in the secondary listening zone 105 (e.g. on the dining room table 107). In other embodiments, the second reference position may e.g. be determined based on a low complexity user input. For example, the user may simply provide a user input indicating that the center of the secondary listening zone 105 is, say, 4 meters to the left and 2 meters in front of the front stereo loudspeakers 109, 111.

The driver 205 may in such scenarios determine the relative gains for the primary signal and the secondary signal, and accordingly the levels of the primary signal component and the secondary signal component, dependent on the loudspeaker position, the first reference position, and the second reference position.

The function for determining the gain based on these parameters may in many embodiments be such that the level of the primary signal component increases for a decreasing distance towards the second reference position. Thus, the function reflects that for a given distance to the first reference position, the first level (the level of the primary signal component) increases relative to the second level (the level of the secondary signal component) as the distance towards the second reference position decreases.

Thus, the system may increase the center signal in the sound rendered from a satellite loudspeaker such that it becomes more pronounced for satellite loudspeakers that are close to the secondary listening zone 105 than for satellite loudspeakers that are further away. The approach may for example differentiate between loudspeakers at equivalent distances to the primary listening zone 103 but at different sides relative to the secondary listening zone 105. For example, if in the example of FIG. 1, the second loudspeaker 115 was positioned as far away from the primary listening zone 103 as the first loudspeaker 113, the use of the second reference position could be used to ensure that the first loudspeaker 113 renders the full audio signal including both the primary signal component and the secondary signal component, whereas the second loudspeaker 115 will only render the secondary signal. Thus, the system will automatically configure the first loudspeaker 113 to provide a full stand-alone sound scene rendering whereas the second loudspeaker 115 will only provide the background/ambient sound.

In some embodiments, the position processor 207 is arranged to categorize the set of loudspeakers 109-115 into different categories with the generation of the drive signals then being dependent on which category the individual loudspeaker is assigned to.

Specifically, the position processor 207 may be arranged to divide the loudspeakers 109-115 into at least two categories with a first category being associated with loudspeakers supporting the primary listening zone 103 and a second category being associated with loudspeakers supporting a secondary listening zone. In some embodiments, the categories may only include these two categories, and thus some loudspeakers may potentially belong to both categories, i.e. they may support both the primary listening zone 103 and the secondary listening zone 105.

The categorization is thus into categories where each category comprises the loudspeakers that are considered to support a specific listening zone. The drive signals will then be generated based on this categorization and specifically the drive signals for the loudspeakers that are considered to belong to the first category are generated to be suitable for providing sound to the primary listening zone 103 whereas the drive signals for the loudspeakers that are considered to belong to the second category are generated to be suitable for providing sound to the secondary listening zone 105. The drive signals for the loudspeakers that are considered to belong to both the first and the second category are generated to be suitable for providing sound to both the primary listening zone 103 and the secondary listening zone 105

It will be appreciated that the description of the categories reflects the processing of the apparatus. I.e. the first category is associated with the loudspeakers that are assumed to support the primary listening zone 103, and specifically with loudspeakers that can render sound that is perceived in the primary listening zone 103. Thus, the first category may be associated with loudspeakers for which (it is assumed that) the acoustic transfer function from the loudspeaker position to the primary listening zone 103 has an attenuation below a given threshold.

Similarly, the second category is associated with the loudspeakers that are assumed to support the secondary listening zone 105, and specifically with loudspeakers that can render sound that is perceived in the secondary listening zone 105. Thus, the second category may be associated with loudspeakers for which (it is assumed that) the acoustic transfer function from the loudspeaker position to the secondary listening zone 105 has an attenuation below a given threshold.

It will be appreciated that the categorization may be based on any suitable algorithm, parameters or approach. For example, in a low complexity embodiment, the categorization may be based on a manual user input, such as e.g. an explicit indication of a distance between each loudspeaker and the primary listening zone 103 and secondary listening zone 105. Thus, it will be appreciated that it is not necessary to explicitly measure e.g. the propagation conditions etc. to determine whether a specific loudspeaker provides sufficient sound to a given listening zone in order to be considered to support it. Rather, any suitable indication or estimate may be used to determine the categories of loudspeakers that are considered or assumed to support the primary listening zone 103 and the secondary listening zone 105.

In the example, the drive signals are generated differently for loudspeakers in the different categories. For example, the first loudspeaker 113 may be categorized to belong to the second category whereas the second loudspeaker 115 may be categorized to belong to the first category. In this case, the drive signal for the first loudspeaker 113 may be generated such that the gain/level of the primary signal component relative to the secondary signal component is significantly higher than for the second loudspeaker 115. For example, the gain for the primary signal may be set to zero and the gain for the secondary signal may be set to one for the second loudspeaker 115. This will result in only the ambient signal being rendered, and thus the second loudspeaker 115 operating as a surround loudspeaker. In contrast, the gain for both the primary signal and the secondary signal may be set to one for the first loudspeaker 113, thereby resulting in a rendering of the full audio signal. Thus, the first loudspeaker 113 is configured as a stand-alone loudspeaker providing the entire sound scene to people in the secondary listening zone 105.

In some embodiments, the system may further consider whether a given loudspeaker belongs to more than one category. For example, if the first loudspeaker 113 is categorized as both supporting the primary listening zone 103 and the secondary listening zone 105, the gain may be set to an intermediate level, e.g. with the gain of the primary signal being set to, say, 0.4 with the gain of the secondary signal still being one. Thus, in such an example, the loudspeaker is configured to boost the center channel in the secondary listening zone 105 while seeking to reduce the impact thereof on the primary listening zone 103.

In many embodiments, the categories may be disjoint, i.e. a given loudspeaker may only belong to one category. In such a case, the first category may be associated with loudspeakers supporting the primary listening zone 103 but not the secondary listening zone 105, and the second category may be associated with loudspeakers supporting the secondary listening zone 105 but not the primary listening zone 103. In addition, the categories may include a third category which is associated with loudspeakers supporting both the primary listening zone 103 and the secondary listening zone 105.

A specific set of gains for the combination of the primary signal and the secondary signals may be stored for each category, and the gains may then be applied when generating the individual drive signal.

As a specific example, a system will be considered comprising two areas in the same room environment (e.g. corresponding to FIG. 1). In the example, each area corresponds to a listening zone. In the approach, a measurement process is undertaken in order to detect or estimate whether the individual loudspeakers of a multi-channel loudspeaker system are in the same space (acoustic zone), in a connected space, or in a different space, corresponding to the first category, the third category, and the second category respectively. This information is then used to adapt the rendering of the audio content. For example, for loudspeakers that are isolated, the audio content should be representative of the entire movie sound track, and not restricted to one channel of a 5.1 sound track.

In the example, the audio system comprises a test generator which is arranged to generate test signals that are then fed to loudspeakers. In addition, a microphone is included which provides a microphone signal which is then analyzed. In some embodiments, the microphone may be a separate microphone which can be moved to different positions, and which e.g. can be positioned within the primary listening zone 103 and/or the secondary listening zone 105 with the position of the microphone then being used as a reference position. In other embodiments, a plurality of microphones may be provided, and specifically each loudspeaker 109-115 may include a microphone.

The microphone(s) may record the test signals, and e.g. based on the detected signals and knowledge of the transmitted test signals, acoustic transfer functions may be determined. Based on the measurements, the classification of the individual loudspeakers may be performed.

For example, the audio system may be entered into a test mode wherein only test signals are generated. The user may be instructed to position the microphone in the center of the primary listening zone 103. Test signals may then sequentially be generated from each loudspeaker, and the average level of the microphone signal for each loudspeaker may be determined. If the detected level for a given loudspeaker is higher than a given threshold, the loudspeaker is considered to support the primary listening zone 103. The process may then be repeated for the microphone at the secondary listening zone 105 to determine the loudspeakers that are estimated to support the secondary listening zone 105. The loudspeakers may then be categorized into those which support only the primary listening zone 103, those only supporting the secondary listening zone 105, and those supporting both the primary listening zone 103 and the secondary listening zone 105.

Thus, once the transfer function/impulse response has been identified for a given loudspeaker, the transfer function/impulse response is analyzed with respect to predetermined metrics to identify whether the loudspeaker is in the primary listening zone 103, the secondary listening zone 105 or both. This process is repeated for all loudspeakers. In this way the categories may correspond to acoustic zones, such as an area around a loudspeaker within a predefined distance, or within a dynamically estimated reverberation radius. A connected acoustic zone may be an area between two acoustic zones where a loudspeaker will be audible in both of the other acoustic zones. An example may be two positions in the same room whose separation is much greater than the reverberation radius, or are partially occluded by an obstacle such as a large piece of furniture or a wall.

A separate acoustic zone may be one isolated from the main space by a physical barrier, such as a wall and doors. The loudspeaker here is effectively isolated from the others and playback in this room is perceived as entirely independent from the playback in other rooms, although the content may be the same.

The classification into the different categories may allow such acoustic environments to be considered and may allow the system to adapt the operation accordingly.

Specific examples of how the detected impulse response may be analyzed include:

If no impulse response is detected, or if the amplitude of the impulse response is below a pre-determined threshold, it is assumed that the transmitting loudspeaker is in an entirely different space to the receiving microphone. Specifically, if the amplitude of the impulse response is below a given level for the primary listening zone 103, the loudspeaker emitting the test signal will not belong to any category associated with loudspeakers supporting the primary listening zone 103. The same applies to the secondary listening zone 105.

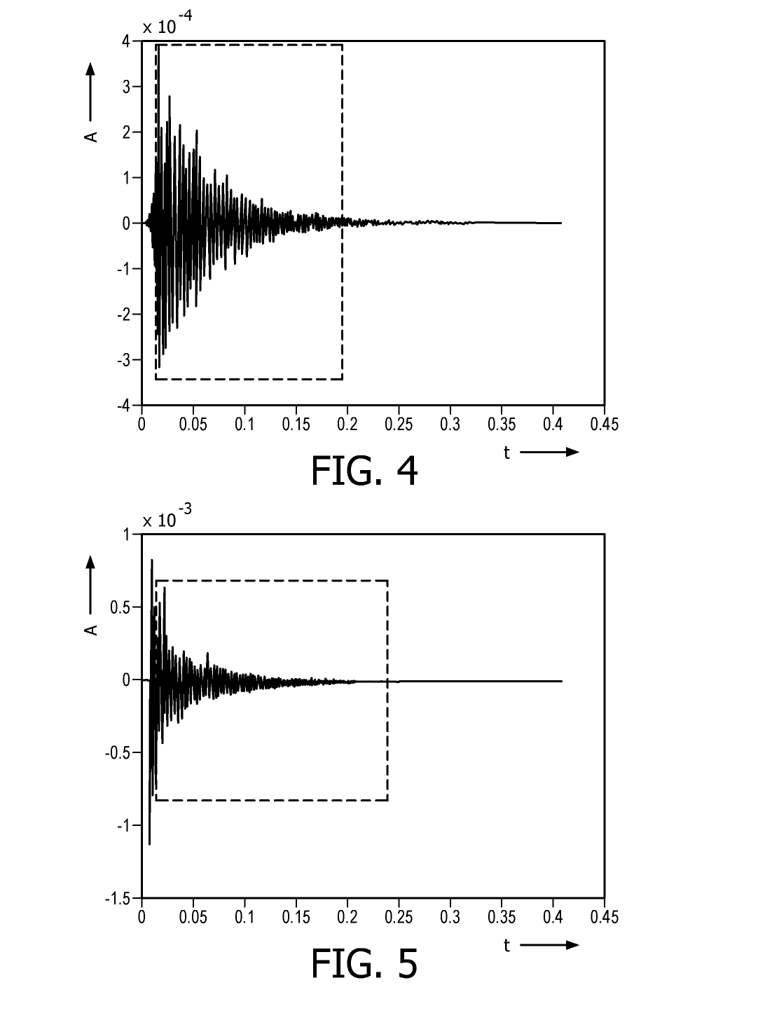

If the microphone is located within an adjoining space, at a great distance, or with no direct line of sight to the test loudspeaker it is likely to be too far from the other loudspeakers to effectively operate as a cohesive multi-channel reproduction system. Time of flight data can be used to estimate the distance between the microphone and all other loudspeakers. Distances larger than, say, 8 m may be considered separate spaces. Another metric for determining whether the loudspeaker is in a separate acoustic space is the profile of the impulse response. A microphone in adjacent space is likely to have a much higher ratio of reverberant sound to direct sound, than a microphone in the shared space. This is illustrated in FIGS. 4 and 5 which show impulse responses recorded in respectively an adjacent space (FIG. 4) and the same space (FIG. 5) as the test loudspeaker. In the former case, the impulse response demonstrates a small impulse and relatively large exponential decay whereas in the latter case, the impulse response demonstrates a relatively large initial impulse and relatively smaller exponential decay. The direct to reverberant ratio is a good marker for determining whether the microphone is in the same space as the transmitting loudspeaker, or in an adjoining space. A third marker might be the reverberant radius; i.e. the distance from a source where the direct sound and the reflected sound become equal.

It will be appreciated that there are many different methods of detecting whether a loudspeaker is in the same acoustic space as another loudspeaker (or microphone). Other examples include frequency response analysis over short time windows, as well as analyzing the shape of the envelope of the impulse response etc.

Once the impulse responses have been recorded and analyzed and the spatial partitioning into different categories has been performed, the audio content for each loudspeaker channel can be optimized. The aim is to provide good intelligibility and coverage in all spaces. If all loudspeakers are located in the same shared space (specifically they all support the primary listening zone 103 and there is no need for specific consideration of the secondary listening zone 105), traditional methods of optimization may be used to optimize playback for a given optimum listening position.

In some embodiments, the impulse responses are determined using the audio content as test signals, i.e. the rendered audio signals are also used as test signals. In this way automatic redistribution of the audio content can be performed in real time without requiring a user prompted calibration. This is particularly advantageous for when the user wishes to move a loudspeaker to another area on the fly. This can be achieved using adaptive filtering processes.

The selection of which of the multichannel signals that are to be used to generate the drive signal for a specific loudspeaker will in some embodiments depend on which category the loudspeaker belongs to. For example, if a satellite loudspeaker belongs to the first category (i.e. it supports only the primary listening zone 103) it will select a subset of the channels. For example, it will only include the ambient or surround signals and will not include the front or center signals. However, if the satellite loudspeaker belongs to the second category (i.e. it supports only the secondary listening zone 105), it will select all the channels. For example, it will include both the center channel, any front channels as well as surround channels. Thus, for a loudspeaker belonging to the first category, only a subset of signals of the multichannel signal generated by the multi-channel signal generator 203 will be included for a loudspeaker belonging to the first category whereas all signals will be included for a loudspeaker belonging to the second category.

In many embodiments, the system may furthermore be arranged to adapt the rendering of audio for a specific listening zone dependent on which loudspeakers are available to support the listening zone.

Specifically, the driver 205 may be arranged to distribute the plurality of signals over a set of loudspeakers which includes only loudspeakers in a subset of categories supporting the primary listening zone 103.

For example, after classification, the system may proceed to determine which loudspeakers are available to support the primary listening zone 103. These loudspeakers will be classified into categories that are associated with support of the primary listening zone 103. E.g. in the previous example, it will include loudspeakers which are classified into the first category or the third category. The driver 205 will then proceed to distribute the plurality of channels over these loudspeakers.

It will be appreciated that any suitable algorithm or process for distributing a number of N spatial channels over a number M of loudspeakers may be used. It will be appreciated that the skilled person is aware of various such algorithms including algorithms for M<N, M>N and M=N.

As an example, the technique known as Vector Base Amplitude Panning may be used as e.g. described in Pulkki V. “Virtual Source Positioning Using Vector Base Amplitude Panning.” J. Audio Eng. Soc., 45(6):456-466, Jun. 1997.

It will be appreciated that in some embodiments, the distribution may be over loudspeakers that only support the primary listening zone 103, i.e. only over loudspeakers in the first category in the specific example.

It will also be appreciated that the same approach may be used for the secondary listening zone 105, i.e. the driver 205 may be arranged to distribute the plurality of channels signals over a set of loudspeakers which includes only loudspeakers in a subset of categories supporting the secondary listening zone 105.

The system may provide a very flexible approach and may allow improved audio rendering in many scenarios. For example, if several loudspeakers support the primary listening zone 103, but one or more loudspeakers have been moved to a different area (e.g. to support the secondary listening zone 105), then the system can redistribute the audio channels to provide an improved listening experience preferably both in the primary listening zone 103 and in the secondary listening zone 105. As a specific example, if one loudspeaker is removed and brought into the adjoining open plan kitchen of FIG. 1, this loudspeaker is no longer suitably placed for rendering of a surround sound channel. It is un-desirable to render only surround sound information in the kitchen as this content contains only ambience, and any listener in the kitchen would therefore receive very little primary audio content. Instead it is desirable to feed a down mixed to mono version of the 5.1 sound track to the loudspeaker located in the kitchen. In this way the user in the kitchen can clearly hear the relevant audio content, even if line of sight is interrupted.

To avoid reducing the stereophonic localization cues for listeners in the optimum listening region, the loudspeaker in the kitchen can be fed with a processed signal, of predetermined loudness and with a predetermined filter, or a filter and amplitude determined by the user. Thus the influence of the loudspeaker in the kitchen on the perceived audio experience in the optimum listening region is minimized, while listeners in the kitchen perceive a clear and full audio experience.

Furthermore, the system may adapt the processing such that the audio content is redistributed over the remaining loudspeakers which support the primary listening zone 103. The redistribution ensures that although one loudspeaker is missing from the conventional multichannel setup, the effect on the overall listening experience is minimized.

In many embodiments and scenarios, the primary signal may at least partly be a speech signal, and the system may be adapted to seek to provide a certain degree of clarity of the speech to users in the secondary listening zone 105. Indeed, the driver 205 may determine a speech clarity indication for the secondary listening zone 105, and may for the first loudspeaker 113 then proceed to adjust the first level relative to the second level based on this speech clarity indication. E.g. if the speech clarity indication indicates that the clarity of the speech of the rendered signal is below a given level, the driver 205 may proceed to increase the gain for the primary signal thereby emphasizing the speech of the center channel relative to the ambient sounds.

As specific examples of the speech clarity indication, the driver 205 may determine a speech intelligibility or clarity measure such as the Speech Transmission Index (STI) or the Clarity Index (C₅₀). These may be determined from the measured impulse responses.

Accordingly, by evaluating whether the intelligibility or clarity is acceptable in the secondary listening zone 105, the level of the center signal rendered from loudspeaker 113 may be adjusted to result in a desired speech clarity level. In some embodiments the formulas for the remixing of the content can be dynamically optimized to maximize or minimize some objective measure. For example, the operators F₁₁₃ and F₁₁₅ previously mentioned may be optimized such that the value of C₅₀ is maximized in specific parts of the listening area or on average in the entire room environment.

In some embodiments, the system may comprise a user detector which generates a user presence indication which is indicative of whether a user is detected in a given area or not. The user presence indication may specifically be indicative of whether a user position falls within the primary listening zone 103 or within the secondary listening zone 105. The system may then adjust the generation of the drive signals and thus the rendered sound depending on the presence of the users.

For example, if the user presence indication indicates that there are no users present in the secondary listening zone 105, the gain/level of the primary signal may be set low, and even to zero, for the first loudspeaker 113. Accordingly, the first loudspeaker 113 will in this scenario assist only in providing ambient sound to listeners in the primary listening zone 103 and will not provide any rendering of the primary signal to the secondary listening zone 105. This will result in an improved audio experience for users in the primary listening zone 103.

Contrary, if the user presence indication indicates that there are no users in the primary listening zone 103 but that there is at least one user in the secondary listening zone 105, then the driver 205 may proceed to increase the gain of the primary signal for the first loudspeaker 113. Specifically, the gain may be set to the same as the ambient signal to provide a rendered sound signal which includes all sound of the original audio signals (weighted equally). Thus an improved user experience is provided to users in the secondary listening zone 105.

If the user presence indication indicates that there are users in both the primary listening zone 103 and the secondary listening zone 105, the system may proceed to compromise between the previous scenarios. For example, the gain for the primary signal may be set to half the gain of the secondary signal, thereby resulting in emphasis of the primary signal in the secondary listening zone 105 without introducing unacceptable interference to the primary listening zone 103.

In these examples, the driver 205 accordingly increases the level of the primary signal component relative to the level of the secondary signal component when the user presence indication indicates that a user is present in the primary listening zone 103.

Thus, detection of the proximity of a user to one or both satellite loudspeakers 113, 115 may be used beneficially to control the system. For example, when it is detected that a user is located close to a satellite loudspeaker at a large distance from the main front loudspeakers, it is likely that this user will benefit from a raised level of the center signal in this satellite in order to optimize intelligibility. In contrast, when no user is detected in the vicinity of the satellite, the center signal is best left out completely from this satellite's signal, since there is no user that would benefit from it while it may actually degrade other users' experiences.

Similarly, detecting presence of a user in the primary listening zone 103 may be beneficial for optimal system control. For example, if a user is present in the primary listening zone 103, the drive signals are generated such that the experience in this area is compromised as little as possible by the sound from the satellite loudspeakers. If, on the other hand, it is detected that no user is present in this area, then the system can be configured so as to optimize the experience for the user(s) near the satellite loudspeakers 113, 115 without considering the experience in the primary listening zone 103.

Detection of a user may be automatic, using any suitable technology. For example, a camera may survey the room and video algorithms arranged to detect the presence of people in specific areas of the video image may be used to generate a user presence indication. As another example, the user detection may involve a simple user action, e.g. the user touching the satellite loudspeaker 113, 115 to indicate that someone is close to the loudspeaker.

In some embodiments, the first loudspeaker 113 may be arranged to radiate the primary signal and the secondary signal with different radiation patterns. For example, the primary signal and the secondary signal may be provided to the first loudspeaker 113 as two separate signals. The first loudspeaker 113 may include two audio transducers which have different radiation patterns, and each audio transducer may be driven by one of the signals. As another example, the first loudspeaker 113 may comprise an audio transducer array that may be driven to provide different audio patterns for the primary signal and the secondary signal.

The patterns may specifically be different such that the secondary signal is rendered with a wider pattern than the primary signal. For example, a primary signal, being a center speech signal, may be rendered in a relatively narrow pattern towards the secondary listening zone 105. In contrast, a secondary signal being an ambient signal may be rendered with a wide pattern. Accordingly, the speech will be focused on the listeners in the secondary listening zone 105 whereas a distributed and more diffuse rendering of the general ambient signal is provided. This may provide an improved experience in the secondary listening zone 105 but may also improve the audio experience in the primary listening zone 103 as the interference from the primary signal being rendered from the first loudspeaker 113 can be reduced.

Thus, in some embodiments, the acoustic radiation pattern of the satellite loudspeakers may be optimized to provide an improved experience to users. Typically, different radiation patterns would be selected for the center- and ambience signals.

In one example, the satellite loudspeaker may have multiple drivers that allow the ambience signals to be reproduced such that they are radiated in all directions except the frontal (on-axis) direction of the satellite loudspeaker (which is typically facing a user located close to it). Complementary to this, the center signal may be reproduced with a frontal loudspeaker driver which typically faces the user. This has several benefits: for the user close to the satellite loudspeaker the clarity and intelligibility of the center signal is improved due to it not being masked by the ambience signals, which are not directly radiated towards the user. This means that the center signal can be reproduced at a lower level while still achieving improved clarity and intelligibility. For the user in the primary listening zone 103, this also has the benefit that his experience is minimally affected by the center signal from the satellites. In addition, the user in the primary listening zone 103 is provided with “diffuse” ambience signals from the satellite loudspeakers thereby enhancing his experience.

In another example, the satellite loudspeakers may contain multiple drivers configured along a vertical axis (vertical line array). If such a vertical line array is driven with identical signals for all drivers, cylindrical sound waves are radiated from the array. One characteristic of such cylindrical waves is that their amplitude drops in level more gradually as a function of distance than the common spherical waves which are generated by a single driver. These different level-vs-distance properties of the vertical line array and a single loudspeaker driver can be used advantageously. If the ambience signal is rendered from all loudspeaker drivers, an ambience sound level that is more homogeneous throughout the room than if a single driver were used is achieved. If, in addition, the center signal is reproduced from only one of the drivers, its level drops much faster with distance, so the sound is more confined to the region around the loudspeaker than the sound from the ambience signal. This is beneficial as it means that the center signal experience for a user in the primary listening zone 103 is less affected by the satellite loudspeakers. Since the driving signals for all drivers of the vertical line array are identical, this solution does in principle not require additional processing- or amplifier channels. Rather, the ambience signal can e.g. simply be divided passively among the drivers.

In some embodiments, the first loudspeaker 113 may be an adjustable multichannel loudspeaker which is arranged to configure a multichannel rendering characteristics dependent on the categorization of the loudspeaker. Specifically, the first loudspeaker 113 may be capable of operating in different rendering modes. In one mode, the first loudspeaker 113 operates as a single channel audio transducer and reproduces all sound homogenously. In another mode, the first loudspeaker 113 may operate as a multi-channel loudspeaker system with different audio signals being rendered in different directions. Specifically, the first loudspeaker 113 may be arranged to operate in a virtual surround sound mode where radiation of different spatial channels occur from the same loudspeaker unit but in different directions. This approach exploits reflections off walls etc. to provide a perception of a virtual surround loudspeaker.

In such a system, the operation of the first loudspeaker 113 may depend on which category it is considered to belong to. Specifically, if it belongs to the first category and accordingly supports the primary listening zone 103, it is likely to be driven as a surround loudspeaker. Accordingly, it will be driven in a single channel mode and simply render the ambient signal.

However, if it belongs to the second category and accordingly supports the secondary listening zone 105, it may be operated in a multi-channel mode wherein different channels are radiated in different directions. Specifically, the first loudspeaker 113 may be operated as a virtual surround sound loudspeaker. This may for example be particularly advantageous in scenarios wherein the first loudspeaker 113 is moved to a completely different room. In this case, a surrounding audio experience is provided to the listener by a single loudspeaker. However, if that loudspeaker is positioned together with other loudspeakers supporting the primary listening zone 103, it will simply render the surround channel.

It will be appreciated that the driver 205 may not utilize or be aware of specific differentiating characteristics of the primary signal and the secondary signal, or how these specifically relate to the underlying sound stage. Rather, the apparatus designates typically one of the multi-channel signals as a primary signal and then proceeds to process this signal in accordance with the rendering algorithm for the primary signal. Similarly, the apparatus designates one (or more) of the multi-channel signals as a secondary signal and then proceeds to process this (these) signal(s) in accordance with the rendering algorithm for a secondary signal. Furthermore, the apparatus generates the primary and secondary signals such that it is assumed or likely that they will correspond to signals with the desired characteristics. Specifically, the primary signal is generated to correspond to a center signal which is likely to contain specific and important sound sources, such as speech. Similarly, the secondary signal is generated to have a high probability (under a given set of circumstances) of corresponding to ambient, diffuse and/or background sources. Thus, for most signals, the apparatus is likely to improve the audio experience. However, it is of course possible that in some specific (typically rare) scenarios, the algorithms may result in an unintended effect. For example, if a signal is received wherein a dominant speech source is located to the rear of listener, this speech source may in some embodiments be treated as a background signal rather than as a dominant single point source. However, such situations are rare, and the improvement provided for most signals will almost always outweigh the unintended effects of unusual signals. Alternatively, the user may be able to switch off the automatic adaptation.

In some embodiments, the system may be arranged to automatically or semi-automatically determine or adapt the first and/or second reference positions corresponding to the primary listening zone 103 and secondary listening zone 105 respectively.

Specifically, the apparatus may comprise a user detector for generating user position indications which are indicative of user positions in the environment. For example, the apparatus may receive an input from a camera surveying the audio environment. The user detector may be arranged to detect user presence in the environment from the captured image. It will be appreciated that various algorithms and techniques will be known to the skilled person for detecting user positions from camera detections or other user inputs. For example, assisted detections using infrared lights may be used to detect positions in two or three dimensions. It will be appreciated that any suitable approach may be used without detracting from the invention.

The position processor 207 may be arranged to determine the first and/or second reference positions based on the detected user position indications. For example, the positions may be analyzed statistically to determine e.g. the occupancy frequency of each of a given set of areas of, say, 1 m². The resulting results may then be analyzed to find separate hotspots which are most frequently occupied. The most occupied region may then be considered the primary listening zone 103 and the second most occupied region may be considered the secondary listening zone 105. The first reference position may then be determined, e.g. as the center of the most occupied region, or as the center of the most occupied 1 m². Similarly, the second reference position may be determined, e.g. as the center of the second most occupied region, or as the center of the most occupied 1 m² in this region,

The approach may be used to initialize the system, and specifically to set up the listening zones without any user involvement. However, in many embodiments, the initial setup may be by a rough manual user input, which may then be dynamically adjusted and fine-tuned in line with the monitored user input.

Thus, in some embodiments, the primary and secondary listening zones (and corresponding reference positions) may be localized using an automatic user localization method, such as a video camera or some other tracking device. The listening zones can be determined or adjusted automatically such that system learns these over time based on statistics of user localization results. E.g. the television 101 may be provided with a webcam and a user detector may determine a user localization ‘heat map’ which can be used to adjust the position of the primary listening zone based on where the user typically sits.

It will be appreciated that the above description for clarity has described embodiments of the invention with reference to different functional circuits, units and processors. However, it will be apparent that any suitable distribution of functionality between different functional circuits, units or processors may be used without detracting from the invention. For example, functionality illustrated to be performed by separate processors or controllers may be performed by the same processor or controllers. Hence, references to specific functional units or circuits are only to be seen as references to suitable means for providing the described functionality rather than indicative of a strict logical or physical structure or organization.

The invention can be implemented in any suitable form including hardware, software, firmware or any combination of these. The invention may optionally be implemented at least partly as computer software running on one or more data processors and/or digital signal processors. The elements and components of an embodiment of the invention may be physically, functionally and logically implemented in any suitable way. Indeed the functionality may be implemented in a single unit, in a plurality of units or as part of other functional units. As such, the invention may be implemented in a single unit or may be physically and functionally distributed between different units, circuits and processors.

Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term comprising does not exclude the presence of other elements or steps.

Furthermore, although individually listed, a plurality of means, elements, circuits or method steps may be implemented by e.g. a single circuit, unit or processor. Additionally, although individual features may be included in different claims, these may possibly be advantageously combined, and the inclusion in different claims does not imply that a combination of features is not feasible and/or advantageous. Also the inclusion of a feature in one category of claims does not imply a limitation to this category but rather indicates that the feature is equally applicable to other claim categories as appropriate. Furthermore, the order of features in the claims do not imply any specific order in which the features must be worked and in particular the order of individual steps in a method claim does not imply that the steps must be performed in this order. Rather, the steps may be performed in any suitable order. In addition, singular references do not exclude a plurality. Thus references to “a”, “an”, “first”, “second” etc. do not preclude a plurality. Reference signs in the claims are provided merely as a clarifying example and shall not be construed as limiting the scope of the claims in any way.

1. An audio apparatus comprising:
a receiver for receiving an audio signal;
a generator for generating a multichannel signal from the audio signal, the multichannel signal comprising a plurality of signals including at least one primary signal and at least one secondary signal;
a driver for generating a set of drive signals comprising at least one drive signal for a loudspeaker of a set of loudspeakers, the set of drive signals comprising at least a first signal component from the primary signal and a second signal component from the secondary signal;
a position circuit for determining a first position of the loudspeaker;
wherein the driver is arranged to adjust a first level of the primary signal component relative to a second level of the secondary signal component in response to the first position relative to a first reference position, wherein the driver is further arranged to adjust the first level relative to the second level in response to the first position relative to a second reference position.

2. The audio apparatus of claim 1 wherein the driver comprises a combiner for combining the primary signal and the secondary signal into a single drive signal for the loudspeaker, the weighting of the primary signal relative to the secondary signal being dependent on the first position relative to the first reference position.

3. The audio apparatus of claim 1 wherein the driver is arranged to increase the first level relative to the second level for an increased distance between the first position and the first reference position.

4. (canceled)

5. The audio apparatus of claim 1 wherein the driver is arranged to increase the first level relative to the second level for an increased distance between the first position and the first reference position and to increase the first level relative to the second level for a decreased distance between the first position and the second reference position.

6. The audio apparatus of claim 1 wherein the position circuit is arranged to determine a loudspeaker position of at least one loudspeaker of the set of loudspeakers and to determine the reference position from the loudspeaker position.

7. The audio apparatus of claim 1 wherein the driver is arranged to determine a speech clarity indication for sound rendered from the loudspeaker, and to adjust the first level relative to the second level in response to the speech clarity indication.

8. The audio apparatus of claim 1 further comprising a user detector for generating a user presence indication indicative of a user presence in a listening zone; and wherein the driver is arranged to adjust the first level relative to the second level in response to the user presence indication.

9. The audio apparatus of claim 8 wherein the user presence indication is indicative of a user position; and wherein the driver is arranged to reduce the first level relative to the second level in response to the user presence indication indicating a user position in a primary listening zone.

10. The audio apparatus of claim 8 wherein the user presence indication is indicative of a user position; and wherein the driver is arranged to increase the first level relative to the second level in response to the user presence indication indicating a user position in a secondary listening area.

11. The audio apparatus of claim 1 further comprising the loudspeaker, and wherein the loudspeaker is arranged to render the primary signal with a different radiation pattern than a radiation pattern for the secondary signal.

12. The audio apparatus as claimed in claim 1 wherein the position circuit is arranged to categorize at least some of the loudspeakers of the set of loudspeakers into categories comprising at least a first category associated with loudspeakers supporting a primary listening zone and a second category associated with loudspeakers supporting a secondary listening zone; and where the driver is arranged to determine the first level relative to the second level in response to the categorization of the loudspeaker.

13. The audio apparatus of claim 12 wherein the first category is associated with loudspeakers not supporting the secondary listening zone and the second category is associated with loudspeakers not supporting the primary listening zone, and the categories further comprises a third category associated with loudspeakers supporting both the primary listening zone and the secondary listening zone.

14. The audio apparatus as claimed in claim 12 wherein the driver is arranged to set the first level relative to the second level higher when the loudspeaker is in the second category than when it is in the first category.

15. audio apparatus as claimed in claim 12 wherein the driver is arranged to generate a single drive signal for the loudspeaker from a set of signals of the plurality of channel signals, the set of signals being dependent on which category the loudspeaker belongs to.

16. The audio apparatus as claimed in claim 12 wherein the driver is arranged to distribute the plurality of channels signals over a set of loudspeakers which includes only loudspeakers in a subset of categories associated with loudspeakers supporting the primary listening zone.

17. The audio apparatus of claim 12 further comprising:
a test generator for generating a test audio signal and feeding it to at least one loudspeaker of the set of loudspeakers;
a microphone receiver for receiving a microphone signal from at least one of a microphone associated with a loudspeaker of the set of loudspeakers and a microphone associated with a listening zone;
and wherein the position circuit is arranged to categorize the loudspeakers in response to the microphone signal.

18. The audio apparatus of claim 12 further comprising the loudspeaker and wherein the loudspeaker is an adjustable multichannel loudspeaker; the apparatus furthermore being arranged to switch the loudspeaker between a single channel mode and a multi-channel mode in response to the categorization of the loudspeaker.

19. The audio apparatus of claim 1 further comprising a user detector for generating user position indications indicative of user positions; and wherein the position circuit is arranged to determine the first reference position in response to the user position indications.

20. A method of operation for an audio system, the method comprising:
receiving an audio signal;
generating a multichannel signal from the audio signal, the multichannel comprising a plurality of signals including at least one primary signal and at least one secondary signal;
generating a set of drive signals comprising at least one drive signal for a loudspeaker of a set of loudspeakers, the set of drive signals comprising at least a first signal component from the primary signal and a second signal component from the secondary signal;
determining a first position of the loudspeaker;
adjusting a first level of the primary signal component relative to a second level of the secondary signal component in response to the first position relative to a first reference position, and further adjusting the first level relative to the second level in response to the first position relative to a second reference position.
